(19) United States
(12) Patent Application Publication
(10) Pub. No.: US 2022/0058402 A1
(43) Pub. Date: Feb. 24, 2022

(54) ADAPTIVE CAMERA SETTINGS TO IMPROVE EFFICIENCY

(71) Applicant: Denso International America, Inc., Southfield, MI (US)

(72) Inventor: Shawn Hunt, Bethel Park, PA (US)

(21) Appl. No.: 17/172,191

(22) Filed: Feb. 10, 2021

Related U.S. Application Data
(60) Provisional application No. 63/067,971, filed on Aug. 20, 2020.

(51) Int. Cl. G06K 9/00; H04N 5/232; B60W 60/00

(52) U.S. Cl. CPC G06K 9/00791; H04N 5/23206; B60W 2555/20; B60W 2420/42; B60W 2420/52; B60W 60/001

(57) ABSTRACT

Systems, methods, and other embodiments described herein relate to selectively adapting settings of a sensor according to a driving context. In one embodiment, a method includes determining a driving context for an ego vehicle according to sensor data about a surrounding environment. The method includes, in response to identifying that the driving context satisfies a sensor threshold, adjusting a parameter associated with a camera in the ego vehicle. The method includes controlling the camera according to the parameter

### CROSS-REFERENCE TO RELATED APPLICATION

This application claims benefit of U.S. Provisional Application No. 63/067,971, filed on Aug. 20, 2020, which is herein incorporated by reference in its entirety.

### TECHNICAL FIELD

The subject matter described herein relates in general to systems and methods for adapting camera settings according to conditions of a surrounding environment, and, more particularly, to improve processing and bandwidth consumption by selectively adapting the camera settings.

### BACKGROUND

Perceiving an environment can be an important aspect for many different computational functions, such as automated vehicle assistance systems, and so on. However, accurately perceiving the environment can be a complex task that balances precision with computational resources in a mobile platform, such as a vehicle. That is, as a general matter, a mobile platform, such as a vehicle, may have limited computational resources due to limitations on a size of a computing device that can be included within the vehicle, available power, and so on. Moreover, higher precision in computations generally relies on higher resolution sensor inputs (i.e., higher resolution images) and/or additional computational resources, such as more processor time/bandwidth. As an additional consideration, different environments can be more complex to understand and navigate. Thus, in the context of an autonomous vehicle, a complex environment may mean that computations should be faster and more precise in order to adequately navigate through such circumstances. Further, capturing high-resolution data when a circumstance does not necessitate high precision can overburden a computing system wasting computing resources. However, allocating resources for interpreting this complex scenario may mean that other processes are under-allocated and thus may not function optimally. Thus, difficulties with effectively allocating resources can affect the ability of such systems to perform optimally.

### SUMMARY

In one embodiment, example systems and methods associated with adapting acquisition and use of sensor data according to a surrounding environment are disclosed. As previously noted, tradeoffs between computational costs, speed, and accuracy may occur when using sensors, such as a camera, to perceive the surrounding environment. Moreover, various driving contexts may benefit from higher precision and/or faster processing. Therefore, a static approach to sensor configuration is generally not optimal.

Thus, in one embodiment, a disclosed approach dynamically assesses a driving context of the vehicle and adapts operation of the sensor and/or of the sensor data itself in order to improve operation and use of computational resources for an associated device, such as an autonomous vehicle. In particular, a monitoring system may monitor for changes in the surrounding environment in order to know when to adapt parameters for controlling a sensor. In one example, the monitoring system determines when an ego vehicle is driving within an urban or highway environment. To achieve this, the monitoring system can use image recognition, GPS location, or other approaches. In the instance of image recognition, the monitoring system processes images from a camera to identify distinctive elements in the surrounding environment that provide cues about the current location for identifying the context, such as highway signs versus traffic lights.

In the context of a highway, the monitoring system may adjust parameters of the camera to use a lower resolution and/or frame rate since autonomous navigation is a less difficult and thus less computationally intensive task in a highway environment as opposed to urban driving where greater precision may be useful. Furthermore, the monitoring system may also monitor for changes in weather conditions, such as rain, snow, fog, and so on. The monitoring system can use similar techniques as noted above to monitor for weather conditions. Thus, in one approach, the monitoring system processes acquired sensor data to identify changes in road surface conditions, wheel slip, instability, changes in brightness, and so on. In adverse weather conditions, the monitoring system can fuse additional sensor modalities with images in order to improve the identification of objects in the surrounding environment. In this way, the monitoring system monitors for the various conditions by using acquired sensor data and then adaptively controls the sensors according to changes in the surrounding environment to improve the use of computational resources and autonomous navigation.

In one embodiment, a monitoring system is disclosed. The monitoring system includes one or more processors and a memory that is communicably coupled to the one or more processors. The memory stores a sensor module including instructions that when executed by the one or more processors cause the one or more processors to determine a driving context for an ego vehicle according to sensor data about a surrounding environment. The sensor module includes instructions to, in response to identifying that the driving context satisfies a sensor threshold, adjust a parameter associated with a camera in the ego vehicle. The sensor module includes instructions to control the camera according to the parameter.

In one embodiment, a non-transitory computer-readable medium is disclosed. The instructions include instructions to determine a driving context for an ego vehicle according to sensor data about a surrounding environment. The instructions include instructions to, in response to identifying that the driving context satisfies a sensor threshold, adjust a parameter associated with a camera in the ego vehicle. The instructions include instructions to control the camera according to the parameter.

In one embodiment, a method is disclosed. In one embodiment, a method includes determining a driving context for an ego vehicle according to sensor data about a surrounding environment. The method includes, in response to identifying that the driving context satisfies a sensor threshold, adjusting a parameter associated with a camera in the ego vehicle. The method includes controlling the camera according to the parameter.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a configuration of a vehicle in which example systems and methods disclosed herein may operate.

FIG. 2 illustrates one embodiment of a monitoring system that is associated with dynamically adapting the use of a sensor according to a driving context.

FIG. 3 illustrates one embodiment of a method associated with adaptive camera settings according to a driving context.

FIG. 4A illustrates a view of an example driving context of a highway environment.

FIG. 4B illustrates a view of an example driving context of an urban environment.

### DETAILED DESCRIPTION

Systems, methods, and other embodiments associated with adapting acquisition and use of sensor data according to a surrounding environment are disclosed. As previously noted, tradeoffs between computational costs, speed, and accuracy may occur when using sensors, such as a camera, to perceive the surrounding environment. For example, because high-resolution images can consume more computational bandwidth, the use of such images may be best suited for instances where higher accuracy is desired instead of all circumstances. Moreover, various driving contexts may benefit from higher precision and/or faster processing, such as complex urban environments, whereas other contexts may not (e.g., highway driving). Therefore, a static approach to sensor configuration is generally not optimal.

Accordingly, in one embodiment, a disclosed approach dynamically assesses a driving context of the vehicle and adapts operation of the sensor and/or of the sensor data itself in order to improve operation and use of computational resources for an associated device, such as an autonomous vehicle. In particular, a monitoring system may monitor for changes in the surrounding environment in order to know when to adapt parameters for controlling a sensor. In one example, the monitoring system determines when an ego vehicle is driving within an urban or highway environment. To achieve this, the monitoring system can use image recognition, GPS location, or other approaches. In the instance of image recognition, the monitoring system processes images from a camera to identify distinctive elements in the surrounding environment that provide cues about the current location for identifying the context, such as highway signs versus traffic lights.

In the context of a highway, the monitoring system may adjust the parameters of the camera to use a lower resolution and/or frame rate since autonomous navigation is a less difficult and thus less computationally intensive task in a highway environment as opposed to urban driving where greater precision may be useful. Furthermore, the monitoring system may also monitor for changes in weather conditions, such as rain, snow, fog, and so on. The monitoring system can use similar techniques as noted above to monitor for weather conditions. Thus, in one approach, the monitoring system processes acquired sensor data to identify changes in road surface conditions, wheel slip, instability, changes in brightness, and so on. In adverse weather conditions, the monitoring system can fuse additional sensor modalities with images in order to improve the identification of objects in the surrounding environment. In this way, the monitoring system monitors for the various conditions by using acquired sensor data and then adaptively controls the sensors according to changes in the surrounding environment to improve the use of computational resources and autonomous navigation.

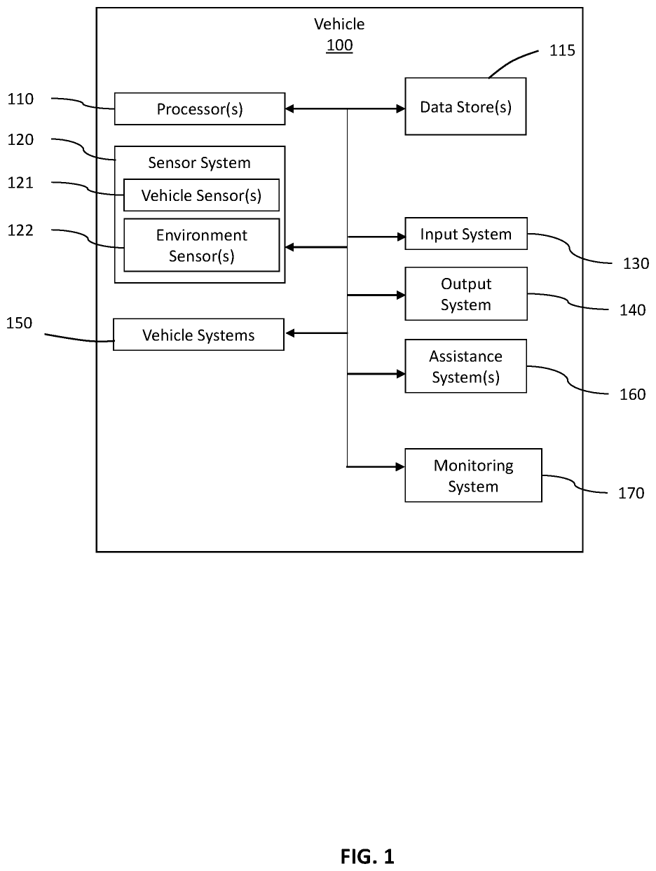

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any electronic device or form of transport that, for example, includes the noted sensor to acquire observations of a surrounding environment, and thus benefits from the functionality discussed herein.

The vehicle 100 also includes various elements. It will be understood that, in various embodiments, the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

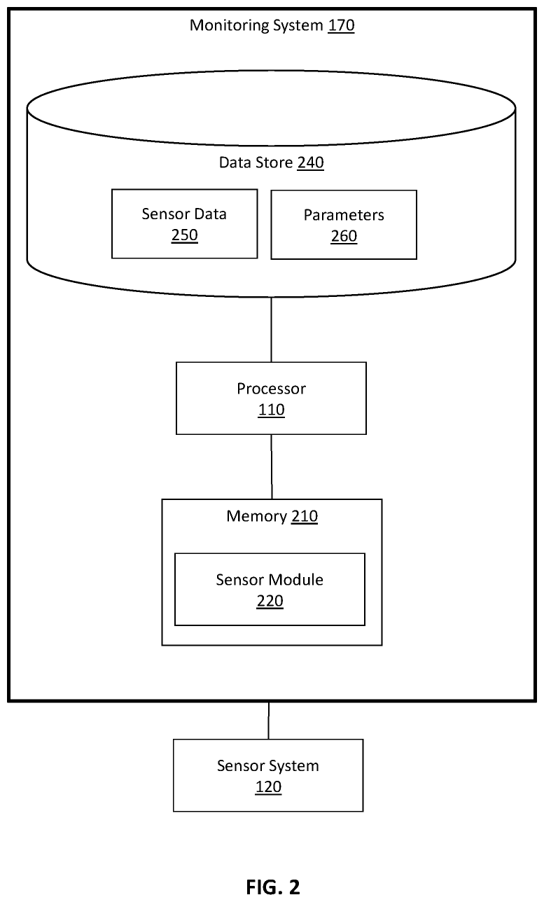

Some of the possible elements of the vehicle 100 are shown in FIG. 1 and will be described along with subsequent figures. A description of many of the elements in FIG. 1 will be provided after the discussion of FIGS. 2-4 for purposes of the brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In either case, the vehicle 100 (also referred to as the ego vehicle 100 herein) includes a monitoring system 170 that functions to dynamically adapt the functioning of at least one sensor within the vehicle 100, such as a camera. Moreover, while depicted as a standalone component, in one or more embodiments, the monitoring system 170 is integrated with the assistance system 160, a sensor system 120, or another similar system of the vehicle 100 to facilitate functions of the other systems/modules. The noted functions and methods will become more apparent with a further discussion of the figures.

With reference to FIG. 2, one embodiment of the monitoring system 170 is further illustrated. As shown, the monitoring system 170 includes a processor 110. Accordingly, the processor 110 may be a part of the monitoring system 170, or the monitoring system 170 may access the processor 110 through a data bus or another communication pathway. In one or more embodiments, the processor 110 is an application-specific integrated circuit that is configured to implement functions associated with a sensor module 220. More generally, in one or more aspects, the processor 110 is an electronic processor such as a microprocessor that is capable of performing various functions as described herein when executing encoded functions associated with the identified module(s).

In one embodiment, the monitoring system 170 includes a memory 210 that stores the sensor module 220. The memory 210 is a random-access memory (RAM), read-only memory (ROM), a hard disk drive, a flash memory, or other suitable memory for storing the sensor module 220. The sensor module 220 is, for example, computer-readable instructions that, when executed by the processor 110, cause the processor 110 to perform the various functions disclosed herein. While, in one or more embodiments, the module 220 is instructions embodied in the memory 210, in further aspects, the module 220 includes hardware, such as processing components (e.g., controllers), circuits, etc. for independently performing one or more of the noted functions.

Furthermore, in one embodiment, the monitoring system 170 includes a data store 240. The data store 240 is, in one embodiment, an electronically-based data structure for storing information. For example, in one approach, the data store 240 is a database that is stored in the memory 210 or another suitable medium, and that is configured with routines that can be executed by the processor 110 for analyzing stored data, providing stored data, organizing stored data, and so on. In any case, in one embodiment, the data store 240 stores data used by the sensor module 220 in executing various functions. In one embodiment, the data store 240 includes sensor data 250, and parameters 260 along with, for example, other information that is used by the module 220.

Accordingly, the sensor module 220 generally includes instructions that function to control the processor 110 to acquire data inputs from one or more sensors (e.g., a camera) of the vehicle 100 that form the sensor data 250. In general, the sensor data 250 includes information that embodies observations of the surrounding environment of the vehicle 100. The observations of the surrounding environment, in various embodiments, can include surrounding lanes, vehicles, objects, obstacles, etc. that may be present in the lanes, proximate to a roadway, within a parking lot, garage structure, driveway, or another area within which the vehicle 100 is traveling or parked.

While the sensor module 220 is discussed as controlling the various sensors to provide the sensor data 250, in one or more embodiments, the sensor module 220 can employ other techniques to acquire the sensor data 250 that are either active or passive. For example, the sensor module 220 may passively sniff the sensor data 250 from a stream of electronic information provided by the various sensors to further components within the vehicle 100. Moreover, the sensor module 220 can undertake various approaches to fuse data from multiple sensors when providing the sensor data 250, which may selectively occur according to the parameters 260. Thus, the sensor data 250, in one embodiment, represents a combination of perceptions acquired from multiple sensors.

Moreover, the sensor module 220, in one embodiment, controls the sensors to acquire the sensor data 250 about an area that encompasses the vehicle 100 in order to provide a comprehensive assessment of the surrounding environment. Of course, depending on the particular implementation, the subject sensor(s) may have a field-of-view that is focused on a rear area behind the vehicle 100, an area alongside the vehicle 100, or another region around the vehicle 100. Moreover, views from multiple sensors may be stitched together to form a wider field of view.

In any case, the sensor module 220 can control the acquisition of the sensor data 250 and the processing of the sensor data 250 in order to adjust the use of computational resources in the vehicle 100. For example, the sensor module 220 can adjust the parameter 260 to change the resolution of images acquired as part of the sensor data 250, a frame rate at which the images are acquired, a color profile (e.g., color, monochrome, etc.) of the images, a number of cameras that acquire the images, and so on. Of course, while the focus is on adapting the acquisition of images, in further aspects, the sensor module 220 may similarly control other types of sensors. For example, the sensor module 220 may further adapt the operation of a LiDAR to acquire fewer points by using fewer scan lines. In general, the sensor module 220 can adapt the operation of different sensors, such as cameras, LiDAR, radar, and so on.

Thus, it should be appreciated that the parameters 260 may include many different attributes of the sensors and how the sensor data 250 is processed. For example, the sensor module 220 adapts the parameters 260, in one embodiment, in registers or other memory locations associated with firmware of a respective sensor. That is, the sensor module 220 can modify internal settings of the sensors in order to cause the change operation that provides the sensor data 250 in a different format (e.g., lower resolution). In a further approach, the sensor module 220 may directly communicate changes in the parameters 260 to the sensors through a communication pathway, which the sensor itself then implements by adapting controls, such as the parameters 260.

Furthermore, beyond controlling the particular ways in which the sensors capture the sensor data 250, the sensor module 220 may further control how the sensor data 250 is processed. For example, the sensor module 220 may adapt one or more of the parameters 260 that controls whether images from a camera are fused with other sensor data, such as radar and/or LiDAR. Accordingly, the sensor module 220 may control the processing and fusing various sources of the sensor data 250 in order to adapt a computational load on the vehicle 100. That is, each separate acquisition, processing, and fusion of data uses additional resources. Thus, the sensor module 220 can adapt the computational load on the vehicle 100 by selectively fusing data from different sensors depending on the current circumstances. In one example, the sensor module 220 may selectively fuse image with other sources of data. In still further examples, the sensor module 220 may fuse images and LiDAR data while not fusing radar data. In yet further examples, the sensor module 220 may fuse data from multiple sensors of the same modality (e.g., multiple images).

In any case, the parameters 260 may take different forms depending on the implementation but are generally configuration values that control the functioning of different sensors and/or the functioning of different systems in the vehicle 100 and how the systems use the sensor data 250. In this way, the sensor module 220 can control how the vehicle 100 allocates available resources in order to better handle environments of differing complexities.

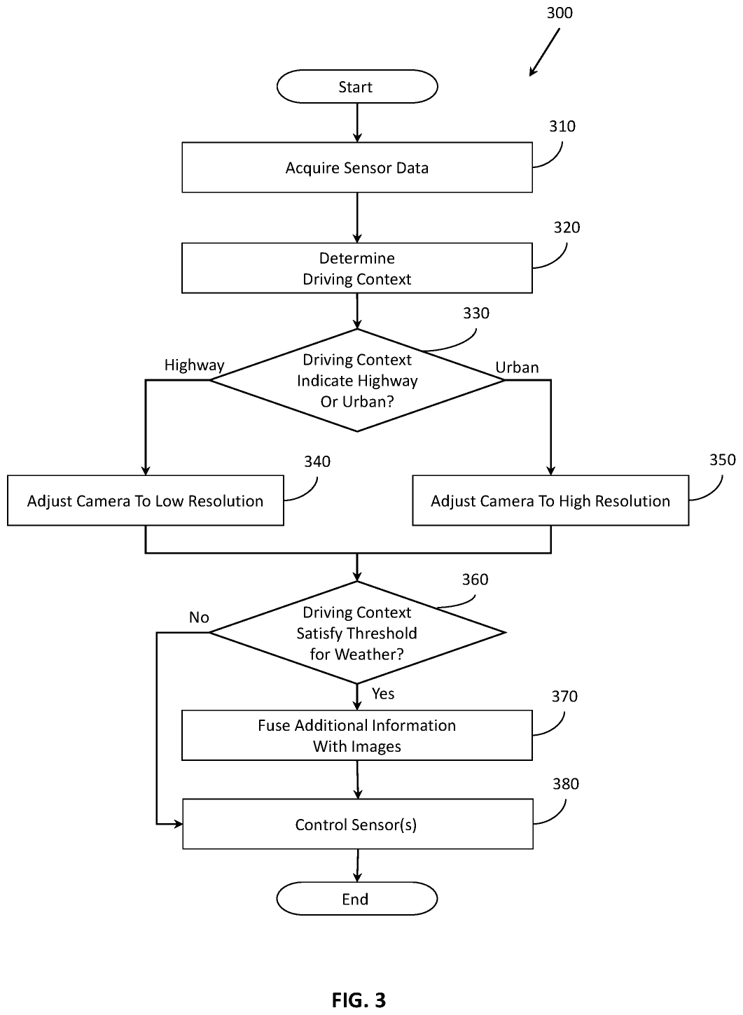

Additional aspects of adaptive settings for acquiring and processing sensor data will be discussed in relation to FIG. 3. FIG. 3 illustrates a method 300 associated with adapting camera settings according to a driving context. Method 300 will be discussed from the perspective of the monitoring system 170 of FIG. 1. While method 300 is discussed in combination with the monitoring system 170, it should be appreciated that the method 300 is not limited to being implemented within the monitoring system 170 but is instead one example of a system that may implement the method 300.

At 310, the sensor module 220 acquires sensor data 250 from at least one sensor of the vehicle 100. In one embodiment, the sensor module 220 acquires the sensor data 250 about a surrounding environment of the vehicle 100. As previously noted, the sensor module 220, in one or more implementations, iteratively acquires the sensor data 250 from one or more sensors of the sensor system 120. The sensor data 250 includes observations of a surrounding environment of the subject vehicle 100, including specific regions that are relevant to functions executed by systems of the vehicle 100, such as assistance system 160 (e.g., activation zones, scanning zones, etc.), an automated driving module (e.g., autonomous driving, semi-autonomous driving, etc.), and so on. Moreover, the sensor module 220 acquires the sensor data 250, in at least one embodiment, from a visible light camera. As such, the sensor data 250 can include images having attributes (e.g., resolution, coloring, etc.) defined according to the parameters 260. Of course, as noted previously, the sensor module 220 may also acquire data from other sensors, such as a LiDAR.

At 320, the sensor module 220 determines a driving context for the ego vehicle 100 according to the sensor data 250. The driving context generally defines, in at least one approach, characteristics about the surrounding environment of the ego vehicle 100. For example, in one approach, the driving context defines weather conditions about adverse weather in the surrounding environment and context characteristics about a type of driving environment, such as highway or urban. In regard to the context characteristics, the monitoring system 170 determines this aspect since an urban driving environment is generally more complex to navigate. That is, an urban environment often includes more dynamic agents moving at different trajectories than the ego vehicle 100 and also includes more complex traffic patterns. For example, a single intersection may include vehicles moving across a path of the ego vehicle 100, in an opposing direction, and turning through the path of the ego vehicle 100, while other agents, such as pedestrians, may also interact with the vehicle 100. Furthermore, an urban environment includes different types of traffic signals/signs, and many different obstructions and obstacles.

By contrast, a highway context is generally limited to other vehicles moving in a same direction as the ego vehicle 100 with limited additional hazards and no traffic signals/signs other than those indicating exits. Accordingly, the difference in complexity between highway driving and urban driving generally results in additional computational resources in order to understand and effectively navigate the urban environment. Thus, the sensor module 220, in one approach, includes a set of machine learning algorithms that the sensor module 220 applies to the sensor data 250 to extract information about the surrounding environment so that the monitoring system 170 can distinguish between urban and highway contexts, and/or other aspects of the environment.

In various implementations, the set of machine learning algorithms may vary but includes at least image recognition algorithms, such as convolutional neural networks (CNNs) or similar networks that can separate and classify aspects of the surrounding environment. In further approaches, the machine learning algorithms may include semantic segmentation algorithms, depth completion algorithms, clustering algorithms, and so on. In general, the machine learning algorithms are deriving information that is useful in identifying aspects of the environment so that characteristics can be imbued therefrom.

Regarding highway/urban determinations, the sensor module 220 analyzes the sensor data 250 to identify context characteristics of the surrounding environment that correspond with highway and urban environments. The context characteristics include aspects, such as pedestrians, highway signs, traffic signals, traffic signs, lane markers, trajectories of nearby objects, and surrounding structures. Thus, the sensor module 220 populates the driving context with the context characteristics as determined according to the analysis of the sensor data 250. In this way, the sensor module 220 can subsequently make determinations about the context.

In yet a further approach, the sensor module 220 can acquire a location of the ego vehicle 100 using a GPS or other form of localization. The sensor module 220 can then compare a current location against a map that identifies different contexts. Accordingly, the sensor module 220 derives the driving context, in this example, from urban and highway context labels in the map that correspond with different locations. Even still, the sensor module 220 may validate this determination according to information derived from image recognition.

At 330, the sensor module 220 determines whether the driving context satisfies a sensor threshold for adjusting the parameters 260. In one approach, the sensor threshold includes multiple different criteria for different actions. Thus, in relation to highway/urban contexts, the sensor threshold may define a critical number of elements that lead to a conclusion of a particular context. For example, in one approach, the sensor module 220 may assign values to different types of elements (e.g., traffic signals, pedestrians, etc. versus highway signs, common trajectories, etc.) and accumulate the values to determine the context. In one configuration, the sensor module may assign positive values to urban elements and negative values to highway elements, and a final accumulated value that is positive or negative may indicate the context. In this case, the sensor threshold itself may simply be a defined value, such as zero.

In yet a further approach, the sensor module 220 may simply identify a single defining characteristic (e.g., road route number with a green highway sign, traffic light, etc.) that unequivocally indicates the context to determine whether the sensor threshold is satisfied for urban or a highway context.

At 340, when the driving context indicates that the ego vehicle 100 is in a highway context, the sensor module 220 adjusts the parameters 260 to cause the camera to produce images in a low resolution (e.g., 4 megapixels to 2 megapixels). In various configurations, the sensor module 220 may also adjust the frame rate, color selection (e.g., full color to monochrome), and so on. In this way, the sensor module 220 reduces the computational resources associated with data handling and processing of the images, thereby freeing resources for other uses and reducing power consumption. In the case where the sensor module 220 is adapting the functioning of additional sensors at block 340, then the sensor module 220 adjusts the parameters 260 accordingly. For example, the sensor module 220 may adapt a scan speed of a LiDAR, a number of scan lines for the LiDAR, and so on. In a further aspect, the sensor module 220 may also control a radar, a number of cameras providing images, ultrasonic sensors, IR cameras, and so on.

At 350, when the driving context indicates that the ego vehicle 100 is in a highway context, the sensor module 220 adjusts the parameters 260 to cause the camera to produce images at a high resolution (e.g., a change of 2 to 4 or more megapixels). As noted above, other attributes of the camera may also be adjusted to provide higher quality images, such as frame rate (e.g., 30 to 60 FPS), color selection (e.g., monochrome to color), and so on. Regarding other sensors, the sensor module 220 may similarly adjust attributes of the sensors to increase quality of acquired data at block 350.

At 360, the sensor module 220 continues by determining whether the driving context satisfies the sensor threshold for adverse weather. For example, as noted above in relation to block 320, the sensor module 220 processes the sensor data 250 to determine the driving context, which can further include determining current weather conditions. In one arrangement, determining the weather conditions includes analyzing the sensor data 250 to identify weather characteristics that correspond with adverse weather. Thus, as noted previously, the sensor module 220 may employ various processing routines (i.e., machine learning algorithms) to derive information from the sensor data 250 that is indicative or not of adverse weather. By way of example, the sensor module 220 may identify rain on a windshield of the ego vehicle 100 or in the environment (e.g., from wet roads or reduced visibility), brightness of images from the camera indicating the presence of snow or sun glare, road surface features (e.g., wet, ice, dry, etc.), wheel slip or inertial measurement unit (IMU) data indicating unexpected sliding, and visibility distance as part of the weather characteristics.

Accordingly, at 360, the sensor module 220 determines when the weather characteristics indicate the occurrence of adverse weather using a threshold determination. In one approach, the sensor module 220 considers the weather conditions to be adverse when the operation of the vehicle 100 is affected either in regard to the ability of the sensors to perceive the surrounding environment or in regard to the ability of the vehicle 100 to maintain safe operation on the roadway due to the presence of ice or other conditions influencing control of the vehicle 100. Thus, the sensor module 220 determines that the sensor threshold for the weather conditions is satisfied when the noted adverse weather conditions are present, and thereby proceeds to block 370. Otherwise, operation continues to block 380.

At 370, the sensor module 220 fuses additional sensor modalities with images from the camera. That is, whereas the sensor module 220 may generally provide images acquired from a camera to the assistance system 160 or other systems, fusing the additional modalities (e.g., LiDAR, radar, etc.) with the images improves the robustness of the information against adverse conditions and also improves accuracy. However, the process of fusing the additional information comes with a cost of increased computational complexity, thereby consuming more computational resources and power. Thus, the monitoring system 170 selectively fuses the additional information with the images when the sensor module 220 determines the need to do so according to the weather conditions.

At 380, the sensor module 220 controls at least the camera according to the parameters 260. That is, depending on how the sensor module 220 modifies the parameters 260 according to the above-defined process, the camera functions to collect the sensor data 250 differently, and further systems function to fuse other information or not with the images. In this way, the monitoring system 170 is able to adapt the use of computational resources according to present needs instead of statically maintaining a high-level of computational load that may use power excessively or overburdens processing systems over time.

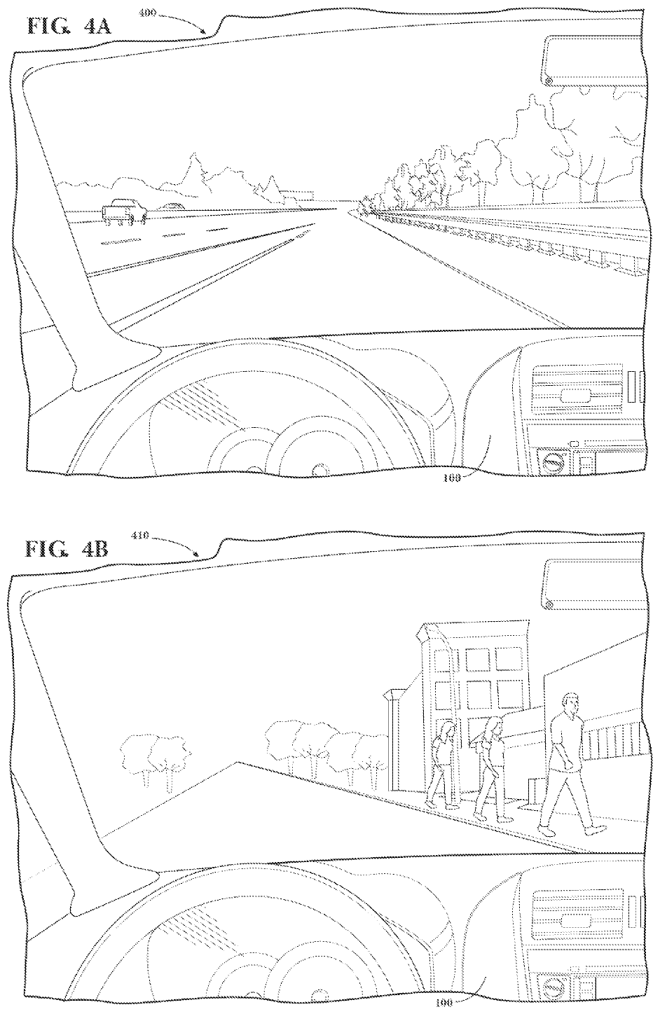

As a further explanation of how the presently disclosed systems and methods function, consider FIGS. 4A and 4B, which illustrate separate driving scenes 400 and 410, respectively. As shown in FIG. 4A, the monitoring system 170 may identify the driving context as a highway context. That is, the scene 400 generally depicts a set of parallel lanes with a single vehicle traveling in the same direction as the ego vehicle 100. Thus, there are no indicators of an urban context, such as traffic signals, pedestrians, and so on, but instead are indicators of a simple highway context. In this case, the monitoring system 170 can adapt the settings of the camera via the parameters 260 to provide less/reduced data, thereby alleviating a burden on computational resources of the vehicle 100.

As shown in FIG. 4B, the monitoring system 170 identifies pedestrians, buildings, and a surface street with just a single lane, which are elements that correspond with an urban context. Thus, there are no indicators associated with a highway, and according to the identified components, the system 170 indicates that the scene 410 is associated with an urban environment. In this case, the monitoring system 170 indicates that the driving context is urban and proceeds to adjust the parameters 260 to provide additional data (e.g., higher resolution, higher frame rate, etc.). In this way, the monitoring system 170 improves autonomous navigation through the environment by using higher quality information.

Additionally, it should be appreciated that the monitoring system 170 from FIG. 1 can be configured in various arrangements with separate integrated circuits and/or electronic chips. In such embodiments, the sensor module 220 is embodied as a separate integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In further embodiments, portions of the functionality associated with the module 220 may be embodied as firmware executable by a processor and stored in a non-transitory memory. In still further embodiments, the module 220 is integrated as hardware components of the processor 110. Moreover, in various approaches, the monitoring system 170 may be integrated as a component with one or more sensors.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies (e.g., method 300 of FIG. 3) are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the monitoring system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 240) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps. In one or more arrangements, the map data can include one or more static obstacle maps. The static obstacle map(s) can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level.

The one or more data stores 115 can include sensor data (e.g., sensor data 250). In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1, however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the monitoring system 170, and/or the assistance system 160 can be operatively connected to communicate with the various vehicle systems 150 and/or individual components thereof. For example, returning to FIG. 1, the processor(s) 110 and/or the assistance system 160 can be in communication to send and/or receive information from the various vehicle systems 150 to control the movement, speed, maneuvering, heading, direction, etc. of the vehicle 100. The processor(s) 110, the monitoring system 170, and/or the assistance system 160 may control some or all of these vehicle systems 150 and, thus, may be partially or fully autonomous.

The processor(s) 110, the monitoring system 170, and/or the assistance system 160 can be operatively connected to communicate with the various vehicle systems 150 and/or individual components thereof. For example, returning to FIG. 1, the processor(s) 110, the monitoring system 170, and/or the assistance system 160 can be in communication to send and/or receive information from the various vehicle systems 150 to control the movement, speed, maneuvering, heading, direction, etc. of the vehicle 100. The processor(s) 110, the monitoring system 170, and/or the assistance system 160 may control some or all of these vehicle systems 150.

The processor(s) 110, the monitoring system 170, and/or the assistance system 160 may be operable to control the navigation and/or maneuvering of the vehicle 100 by controlling one or more of the vehicle systems 150 and/or components thereof. For instance, when operating in an autonomous mode, the processor(s) 110, the monitoring system 170, and/or the assistance system 160 can control the direction and/or speed of the vehicle 100. The processor(s) 110, the monitoring system 170, and/or the assistance system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the monitoring system 170 and/or the assistance system 160 can function to perform various driving-related tasks. The vehicle 100 can include one or more actuators. The actuators can be any element or combination of elements operable to modify, adjust and/or alter one or more of the vehicle systems or components thereof to responsive to receiving signals or other inputs from the processor(s) 110 and/or the assistance system 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more modules as part of an assistance system 160. The assistance system 160 can be configured to receive data from the sensor system 120 and/or any other type of system capable of capturing information relating to the vehicle 100 and/or the external environment of the vehicle 100. In one or more arrangements, the assistance system 160 can use such data to generate one or more driving scene models. The assistance system 160 can determine the position and velocity of the vehicle 100. The assistance system 160 can determine the location of obstacles, or other environmental features, including traffic signs, trees, shrubs, neighboring vehicles, pedestrians, and so on.

The assistance system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system 160 either independently or in combination with the monitoring system 170 can be configured to determine travel path(s), current autonomous driving maneuvers for the vehicle 100, future autonomous driving maneuvers, and/or modifications to current autonomous driving maneuvers based on data acquired by the sensor system 120, driving scene models, and/or data from any other suitable source such as determinations from the sensor data 250 as implemented by the module 220. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system 160 can be configured to implement determined driving maneuvers. The assistance system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A monitoring system, comprising:
one or more processors; and
a memory communicably coupled to the one or more processors and storing:
a sensor module including instructions that when executed by the one or more processors cause the one or more processors to:
determine a driving context for an ego vehicle according to sensor data about a surrounding environment;
in response to identifying that the driving context satisfies a sensor threshold, adjust a parameter associated with a camera in the ego vehicle; and
control the camera according to the parameter.

2. The monitoring system of claim 1, wherein the sensor module includes instructions to identify that the driving context satisfies a sensor threshold including instructions to determine whether the driving context is one of highway and urban according to the sensor data, and
wherein the sensor module includes instructions to adjust the parameter including instructions to modify at least one of a frame rate of the camera, a resolution of images generated by the camera, and color selection.

3. The monitoring system of claim 2, wherein the sensor module includes instructions to determine whether the driving context including instructions to analyze the sensor data using at least image recognition of images in the sensor data to identify context characteristics of the surrounding environment that correspond with highway and urban environments, and
wherein the context characteristics include pedestrians, highway signs, traffic signals, traffic signs, lane markers, and surrounding structures.

4. The monitoring system of claim 1, wherein the sensor module includes instructions to identify that the driving context satisfies a sensor threshold including instructions to determine whether weather conditions are adverse according to the sensor data, and
wherein the sensor module includes instructions to adjust the parameter including instructions to fuse additional sensor modalities with images from the camera when the driving context indicates the weather conditions are adverse to controlling the ego vehicle.

5. The monitoring system of claim 4, wherein the sensor module includes instructions to determine whether the weather conditions are adverse including instructions to analyze the sensor data to identify weather characteristics that correspond with adverse weather, and
wherein the weather characteristics include rain on a windshield of the ego vehicle, brightness of images from the camera, road surface features, wheel slip, and visibility distance.

6. The monitoring system of claim 1, wherein the sensor module includes instructions to determine the driving context including instructions to apply a set of machine learning algorithms to the sensor data to extract information about the surrounding environment, and
wherein the set of machine learning algorithms includes at least image recognition algorithms, and semantic segmentation algorithms.

7. The monitoring system of claim 1, wherein the sensor module includes instructions to acquire the sensor data using the camera, and at least one of a LiDAR, and a radar, and
wherein the sensor data is an observation of the surrounding environment of the ego vehicle.

8. The monitoring system of claim 1, wherein the ego vehicle operates autonomously to navigate the surrounding environment.

9. A non-transitory computer-readable medium storing instructions that, when executed by one or more processors, cause the one or more processors to:
determine a driving context for an ego vehicle according to sensor data about a surrounding environment;
in response to identifying that the driving context satisfies a sensor threshold, adjust a parameter associated with a camera in the ego vehicle; and
control the camera according to the parameter.

10. The non-transitory computer-readable medium of claim 9, wherein the instructions to identify that the driving context satisfies a sensor threshold include instructions to determine whether the driving context is one of highway and urban according to the sensor data, and
wherein the instructions to adjust the parameter include instructions to modify at least one of a frame rate of the camera, a resolution of images generated by the camera, and color selection.

11. The non-transitory computer-readable medium of claim 10, wherein the instructions to determine whether the driving context include instructions to analyze the sensor data using at least image recognition of images in the sensor data to identify context characteristics of the surrounding environment that correspond with highway and urban environments, and
wherein the context characteristics include pedestrians, highway signs, traffic signals, traffic signs, lane markers, and surrounding structures.

12. The non-transitory computer-readable medium of claim 9, wherein the instructions to identify that the driving context satisfies a sensor threshold include instructions to determine whether weather conditions are adverse according to the sensor data, and
wherein the instructions to adjust the parameter include instructions to fuse additional sensor modalities with images from the camera when the driving context indicates the weather conditions are adverse to controlling the ego vehicle.

13. The non-transitory computer-readable medium of claim 12, wherein the instructions to determine whether the weather conditions are adverse include instructions to analyze the sensor data to identify weather characteristics that correspond with adverse weather, and
wherein the weather characteristics include rain on a windshield of the ego vehicle, brightness of images from the camera, road surface features, wheel slip, and visibility distance.

14. A method, comprising:
determining a driving context for an ego vehicle according to sensor data about a surrounding environment;
in response to identifying that the driving context satisfies a sensor threshold, adjusting a parameter associated with a camera in the ego vehicle; and
controlling the camera according to the parameter.

15. The method of claim 14, wherein identifying that the driving context satisfies a sensor threshold includes determining whether the driving context is one of highway and urban according to the sensor data, and
wherein adjusting the parameter includes modifying at least one of a frame rate of the camera, a resolution of images generated by the camera, and color selection.

16. The method of claim 15, wherein determining whether the driving context is one of highway and urban includes analyzing the sensor data using at least image recognition of images in the sensor data to identify context characteristics of the surrounding environment that correspond with highway and urban environments, and
wherein the context characteristics include pedestrians, highway signs, traffic signals, traffic signs, lane markers, and surrounding structures.

17. The method of claim 14, wherein identifying that the driving context satisfies a sensor threshold includes determining whether weather conditions are adverse according to the sensor data, and
wherein adjusting the parameter includes fusing additional sensor modalities with images from the camera when the driving context indicates the weather conditions are adverse to controlling the ego vehicle.

18. The method of claim 17, wherein determining whether the weather conditions are adverse includes analyzing the sensor data to identify weather characteristics that correspond with adverse weather,
wherein the weather characteristics include rain on a windshield of the ego vehicle, brightness of images from the camera, road surface features, wheel slip, and visibility distance.

19. The method of claim 14, wherein determining the driving context includes applying a set of machine learning algorithms to the sensor data to extract information about the surrounding environment, and
wherein the set of machine learning algorithms includes at least image recognition algorithms, and semantic segmentation algorithms.

20. The method of claim 14, further comprising:
acquiring the sensor data using the camera, and at least one of a LiDAR, and a radar, wherein the sensor data is an observation of the surrounding environment of the ego vehicle.
